(19) United States
(12) Patent Application Publication
(10) Pub. No.: US 2023/0161539 A1
(43) Pub. Date: May 25, 2023

(54) ASSISTED COLLABORATIVE NAVIGATION IN SCREEN SHARE ENVIRONMENTS

(71) Applicant: International Business Machines Corporation, Armonk, NY (US)

(72) Inventors: Alan Chung, Hopewell Junction, NY (US); Jeremy R. Fox, Georgetown, TX (US); Jacob Ryan Jepperson, St. Paul, MN (US); Spencer Thomas Reynolds, Austin, TX (US); Zachary A. Silverstein, Georgetown, TX (US)

(21) Appl. No.: 17/456,243

(22) Filed: Nov. 23, 2021

(51) Int. Cl. G06F 3/14; G06F 21/62; G06F 9/451; G10L 15/26

(52) U.S. Cl. CPC G06F 3/1454; G06F 21/6218; G06F 9/451; G10L 15/26

(57) ABSTRACT

A method, computer system, and a computer program product for assisted collaborative navigation in a screen share environment is provided. The present invention may include identifying an action for a first user to perform on a computing device based on a feedback transmitted from a second user to the first user. The present invention may also include determining that the identified action is not being performed on the computing device. The present invention may further include displaying, on the computing device, a user interface (UI) guidance to assist the first user to perform the identified action associated with the feedback transmitted from the second user to the first user.

### BACKGROUND

The present invention relates generally to the field of computing, and more particularly to screen sharing technology.

Screen sharing, also referred to as desktop sharing and application sharing, is a helpful collaborative service for providing technical support, user education, or knowledge transfer. During a screen sharing session, a presenter may share their screen with a participant in order to receive technical support, user education, or knowledge transfer. In various instances, it may be difficult for the presenter to follow the participant's spoken guidance when engaged in a screen sharing session. However, authorizing remote access to the participant may not be an option and may pose a security risk.

### SUMMARY

Embodiments of the present invention disclose a method, computer system, and a computer program product for assisted collaborative navigation in a screen share environment. The present invention may include identifying an action for a first user to perform on a computing device based on a feedback transmitted from a second user to the first user. The present invention may also include determining that the identified action is not being performed on the computing device. The present invention may further include displaying, on the computing device, a user interface (UI) guidance to assist the first user to perform the identified action associated with the feedback transmitted from the second user to the first user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is a schematic block diagram of a screen sharing environment according to at least one embodiment;

FIG. 3 is a schematic block diagram of exemplary user interface guidance implementations according to at least one embodiment;

FIG. 4 is an operational flowchart illustrating a process for collaborative interaction according to at least one embodiment;

FIG. 5 is a block diagram of internal and external components of computers and servers depicted in FIG. 1 according to at least one embodiment;

FIG. 6 is a block diagram of an illustrative cloud computing environment including the computer system depicted in FIG. 1, in accordance with an embodiment of the present disclosure; and

FIG. 7 is a block diagram of functional layers of the illustrative cloud computing environment of FIG. 6, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for assisted collaborative navigation in screen share environments. As such, the present embodiment has the capacity to improve the technical field of screen sharing by assisting in guiding a user in these collaborative interactions with directional and contextual guidance along with physically moving the cursor for the user based on spoken instructions. More specifically, a collaborative interaction program may receive audio instructions from a second user to a first user. Then, the collaborative interaction program may determine an action for the first user to perform on a computing device based on the instructions from the second user. Next, the collaborative interaction program may determine that the first user is not performing the action. Accordingly, the collaborative interaction program may present, to the first user on the computing device, guidance on performing the action on the computing device.

As described previously, screen sharing is a helpful collaborative service for providing technical support, user education, or knowledge transfer. During a screen sharing session, a presenter may share their screen with a participant in order to receive technical support, user education, or knowledge transfer. In various instances, it may be difficult for the presenter to follow the participant's spoken guidance when engaged in a screen sharing session. For example, instructions such as, “click on the x on the right” or “move your cursor a bit to the left and click the Support Tab” may often be frustrating and ineffective for some users. However, authorizing remote access to the participant may not be an option and may pose a security risk.

Therefore, it may be advantageous to, among other things, provide a way to assist a user during screen sharing collaborative interactions by enabling directional and contextual user interface guidance along with automatically moving the cursor for the user based on the spoken instruction.

According to one embodiment, a collaborative interaction program may translate the intent of a verbal command (e.g., given from second user to first user, not user to device) or instruction using Natural Language Processing (NLP) and provide visual guidance on screen to help the first user accomplish the direction/instructions from the second user. For example, the second user may tell the first user to move their cursor to the right, and the first user receiving those instructions may see an arrow on screen near their cursor pointing to the right or even actively reposition the cursor for the first user.

According to at least one embodiment, the collaborative interaction program may process the spoken instructions using NLP to display navigational overlay(s) based on user's relative position of a cursor on the screen. In one embodiment, movement trends may be ingested and processed to display the navigational overlays. According to at least one embodiment, the spoken instructions may only be processed from specific authorized users.

According to at least one embodiment, the collaborative interaction program may process the spoken instructions using NLP to reposition the user's cursor on specific elements based on descriptors and processing including but not limited to, colors, shapes, text, and location. In one embodiment, the spoken instructions may be processed to capture magnitude actions in addition to directional ones.

According to at least one embodiment, the collaborative interaction program may utilize NLP to process speech, authenticate that speech based on meeting participants against available commands, and present that command on the screen in a guided, overlay or automatic action method to best assist the first user. According to one embodiment, instead of automatically executing a computer function from speech, the collaborative interaction program may process speech from multiple users, determine the correct instructions, validate against user action, and provide helpful annotations on the screen of the first user.

According to at least one embodiment, the collaborative interaction program may shadow or otherwise annotate the cursor of the screen sharing user so that the instructor may easily locate the cursor and provide guidance. In one embodiment, the collaborative interaction program may process eye tracking data from the instructor and heatmaps to guide a digital cursor.

According to at least one embodiment, the collaborative interaction program may process the historical trends for user actions to calculate a threshold of time to attempt the movement before the user interface guidance is shown. In one embodiment, the collaborative interaction program may detect window change to determine proper user interaction.

According to one embodiment, the collaborative interaction program may provide enhanced accessibility feature to address impaired visual acuity (e.g., macular degeneration) where the collaborative interaction program may take actions to highlight or enlarge a section of the screen for easier detection.

According to at least one embodiment, the collaborative interaction program may support simultaneous delivery of its functionality, such as, for example, in a one to many (1:N) group instruction. Based upon each user's ability to follow the instructions of a leader or instructor, the collaborative interaction program may run in parallel for multiple users concurrently. This embodiment may enable unique instructional overlays to be provided for each person within a live dynamic online virtual meeting. In one embodiment, the collaborative interaction program may enable each user to have a unique assisted collaborative navigation experience based on their own ability to “follow” along with the leader or instructor.

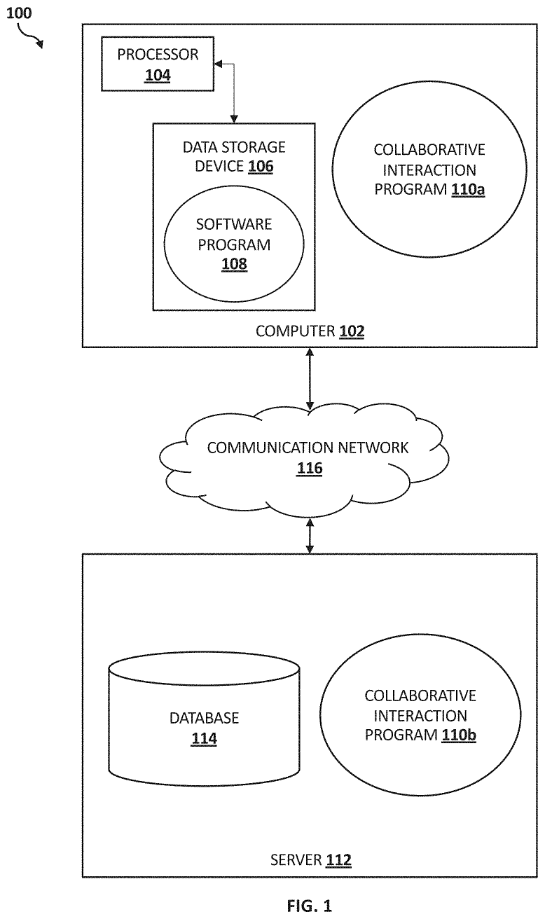

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a collaborative interaction (CI) program 110a. The networked computer environment 100 may also include a server 112 that is enabled to run a CI program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

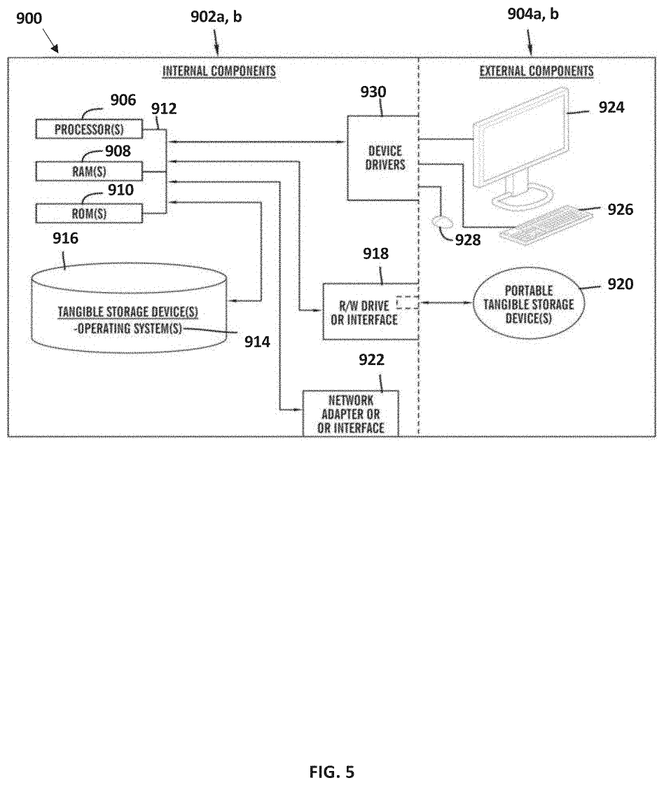

The client computer 102 may communicate with the server computer 112 via the communications network 116. The communications network 116 may include connections, such as wire, wireless communication links, or fiber optic cables. As will be discussed with reference to FIG. 5, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the CI program 110a, 110b may interact with a database 114 that may be embedded in various storage devices, such as, but not limited to a computer/mobile device 102, a networked server 112, or a cloud storage service.

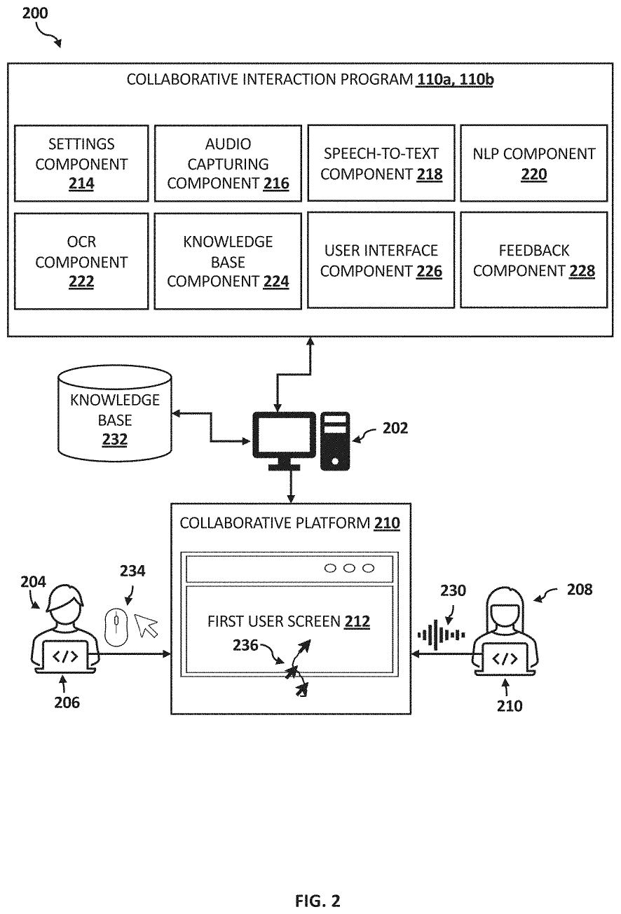

According to the present embodiment, a user using a client computer 102 or a server computer 112 may use the CI program 110a, 110b (respectively) to display a user interface guidance to assist a first user to perform an identified action associated with a feedback transmitted from a second user to a first user. Embodiments of the present disclosure are explained in more detail below with respect to FIGS. 2 to 4.

Referring now to FIG. 2, a schematic block diagram of a screen sharing environment 200 implementing the collaborative interaction (CI) program 110a, 110b according to at least one embodiment is depicted. According to one embodiment, the screen sharing environment 200 may include one or more components (e.g., client computer 102; server computer 112; communication network 116) of the computer environment 100 discussed above with reference to FIG. 1.

According to one embodiment, the screen sharing environment 200 may include a computer system 202 having a tangible storage device and a processor that is enabled to run the CI program 110a, 110b. In one embodiment, the computer system 202 may include one or more client computers 102 and/or one or more server computers 112. In various embodiments, the client computer 102 and/or the server computer 112 of the computer system 202 may include a workstation, a personal computing device, a laptop computer, a desktop computer, a thin-client terminal, a tablet computer, a smart telephone, a smart watch or other smart wearable, or other electronic devices.

According to one embodiment, a first user 204, using a first computing device 206, may interact with the CI program 110a, 110b running on computer system 202 to initiate a virtual meeting with a second user 208, using a second computing device 210. In one embodiment, the virtual meeting may include the first user 204 sharing a first user screen 212 (e.g., of first computing device 206) with the second user 208 using a collaborative platform 210.

In one embodiment, the virtual meeting may include any computerized version of a real-time conversation/discussion between the first user 204 and the second user 208. In one embodiment, the CI program 110a, 110b may support the real-time audio and video streaming between the first user 204 and the second user 208 logged into the virtual meeting.

According to at least one embodiment of the present disclosure, the virtual meeting may be initiated for the purpose of providing the first user 204 with technical or product support, user education, or transfer of knowledge by the second user 208. In various embodiments, the first user 204 may be referred to as a host, a presenter, a student, or any other screen sharing user. In various embodiments, the second user 208 may be referred to as an external participant, an instructor, a viewer, or any other role tasked with guiding the first user 204 to interact with the shared first user screen 212 based on feedback transmitted from the second user 208 to the first user 204.

According to at least one embodiment, the CI program 110a, 110b may include a single computer program or multiple program components/modules or sets of instructions being executed by the processor of the computer system 202. The CI program 110a, 110b may include routines, objects, components, units, logic, data structures, and actions that may perform particular tasks or implement particular abstract data types. The CI program 110a, 110b may be practiced in distributed cloud computing environments where tasks may be performed by remote processing devices which may be linked through the communication network 116. In one embodiment, the CI program 110a, 110b may include program instructions that may be collectively stored on one or more computer-readable storage media. As shown in the illustrated embodiment of FIG. 2, the CI program 110a, 110b may include a settings component 214, an audio capturing component 216, a speech-to-text component 218, a natural language processing (NLP) component 220, an optical character recognition (OCR) component 222, a knowledge base component 224, a user interface (UI) component 226, and a feedback component 228.

According to one embodiment, the settings component 214 of the CI program 110a, 110b may enable the first user 204 to opt-in to integrating the CI program 110a, 110b with any collaborative platform 210 selected by the first user 204. In one embodiment, the first user 204 may opt-in to the CI program 110a, 110b by providing access to the collaborative platform 210 to move and position a cursor associated with the first user device 206 and draw UI elements via overlay. In one embodiment, the settings component 214 may also enable the first user 204 to create a user profile. In one embodiment, the user profile may enable the first user 204 to enter any information which may impact the ability of the first user 204 to interact with the screen sharing capabilities of the CI program 110a, 110b (e.g., impaired visual acuity). In some embodiments, historical data associated with the ability of the first user 204 to use the screen sharing capabilities of the CI program 110a, 110b may be stored with the user profile. This historical data may be used to calculate a personalized (e.g., for the first user 204) threshold of time to attempt a UI movement before UI guidance is provided to the first user 204.

According to one embodiment, the CI program 110a, 110b may receive an approval from the first user 204 indicating the second user 208 as an authorized speaker. As such, the CI program 110a, 110b may process the feedback transmitted from the second user 208 based on the received approval. More specifically, the settings component 214 may enable the first user 204 to designate a set of approved individuals or roles whose spoken or textual feedback may be used to drive the CI program 110a, 110b for providing assisted collaborative UI navigation (e.g., UI guidance). In one embodiment, the second user 208 may be part of the group of individuals or roles that have been approved by the first user 204. In some embodiments, the first user 204 may interact with multiple participants in a virtual meeting (e.g., including the second user 208) via the collaborative platform 210. In such embodiments, the CI program 110a, 110b may enable only the feedback from the second user 208 (e.g., based on the approval of the first user 204) to drive the assisted collaborative UI navigation. In some embodiments, the second user 208 may include multiple users, such as, for example, two support technicians in a virtual meeting with the first user 204.

According to one embodiment, the first user 204 may begin a screen sharing session with any number of external participants (e.g., including the second user 208) and actuate the CI program 110a, 110b. In one embodiment, the CI program 110a, 110b may implement the audio capturing component 216 to capture the audio feedback from the second user 208 (e.g., authorized speaker; approved individuals or roles). More specifically, the audio capturing component 216 may capture one or more input audio streams 230 received via the second user device 210.

According to one embodiment, the CI program 110a, 110b may implement the speech-to-text component 218 to process the input audio streams 230. In one embodiment, the speech-to-text component 218 may implement machine learning techniques to transcribe the input audio streams 230 to text data.

According to one embodiment, the CI program 110a, 110b may implement the NLP component 220 to process the text data of the input audio streams 230 to determine if the audio feedback (e.g., input audio streams 230) from the second user 208 includes an action criteria (e.g., above threshold for action criteria). In one embodiment, the NLP component 220 may analyze the text data to extract metadata from the content such as, for example, concepts, intents, entities, keywords, categories, sentiment, relations, and semantic roles. In one embodiment, the CI program 110a, 110b may implement the knowledge base component 224 to query a knowledge base 232 based on the extracted metadata. In one embodiment, the knowledge base 232 may be configured to classify the contents of the text data (e.g., based on the extracted metadata) as either including an action criteria (e.g., above threshold for action criteria) or not (e.g., below threshold for action criteria). Examples of action criteria statements may include, “move your mouse to the left;” “drag your cursor to the right;” and “it is the box at the top of your screen.” According to one embodiment, once the text data is classified as including the action criteria, the CI program 110a, 110b may identify the action indicated in the classified audio input stream based on the metadata extracted from the text.

According to one embodiment, the CI program 110a, 110b may implement the OCR component 222 in conjunction with the NLP component 220 to enhance the accuracy of the guidance from the input audio streams 230. In one embodiment, the OCR component 222 may be implemented to recognize any text on the first user screen 212 that is referenced by the second user 208 in the input audio streams 230. For example, if the second user 208 instructed the first user 204 to click on the “tools” drop down menu button on the first user screen 212, the OCR component 222 may enable the CI program 110a, 110b to recognize the word “tools” to identify the specific drop down menu button on the first user screen 212.

According to one embodiment, once the content of the input audio streams 230 is classified as an action criteria, the CI program 110a, 110b may implement the UI component 226 to track one or more cursor movements 234 of the first user device 206 to determine if the first user 204 is performing the actions instructed by the second user 208 (e.g., identified actions). In one embodiment, the UI component 226 may track the magnitude and vector of the cursor movements 234 to determine whether to trigger an automatic UI guidance 236 to assist the first user 204. In one embodiment, the CI program 110a, 110b may retrieve and implement a triggering threshold which may be specific (e.g., personalized) for each first user 204. In one embodiment, the triggering threshold may include an algorithmic association between the magnitude and vector of the cursor movements 234 and the amount of time spent by the first user 204 on attempting the action. In one embodiment, the triggering threshold may indicate a timeframe for performing the identified action. For example, the threshold may be triggered if the identified action is not directly performed by the first user 204 within 30 seconds.

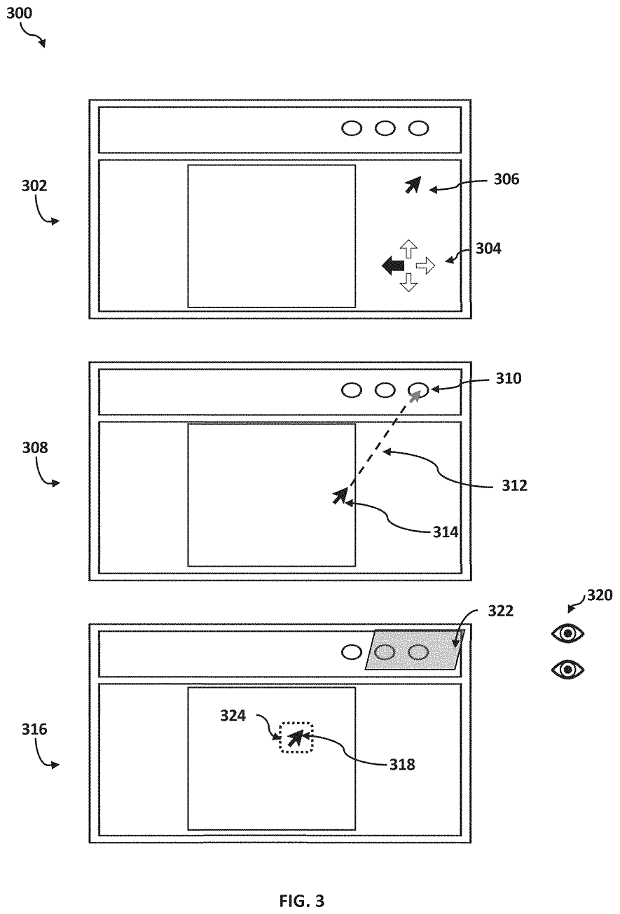

According to one embodiment, if the CI program 110a, 110b determines that the first user 204 has taken the correct action (e.g., determined based on processing the input audio streams 230) within the triggering threshold, no UI guidance 236 is provided to the first user 204. However, if the CI program 110a, 110b determines that the triggering threshold has passed and the first user 204 is not following the correct instructions or is not fast enough, the CI program 110a, 110b may implement the UI component 226 to initiate the UI guidance 236 to assist the first user 204. Various embodiments of the UI guidance 236 will be detailed further with reference to FIG. 3.

According to one embodiment, once the CI program 110a, 110b registers the action as being completed, the UI component 226 may remove the UI guidance 236 and the feedback component 228 may log any user feedback for future iterations of screen sharing sessions. In one embodiment, the user feedback may indicate which UI guidance 236 was implemented and/or most effective in guiding the first user 204 to complete the actions instructed by the second user 208. In one embodiment, the feedback component 228 may automatically capture the user feedback and store the user feedback in the knowledge base 232. It is contemplated that the user feedback may enable the CI program 110a, 110b to continuously learn from past iterations to provide the most effective UI guidance 236 in future sessions.

Referring now to FIG. 3, a schematic block diagram 300 of exemplary UI guidance 236 implementations of the CI program 110a, 110b according to at least one embodiment is depicted.

According to one embodiment, the CI program 110a, 110b may provide or display a relative navigational hint 302 on the first user screen. In one embodiment, the relative navigational hint 302 may include a UI overlay 304 which may provide directional guidance relative to a current cursor (e.g., pointer) position 306 to direct the first user 204 to complete the action instructed by the second user 208. In one embodiment, the UI overlay 304 may include a quad arrow. In one embodiment, each directional arrow of the quad arrow may be associated with a respective direction on the first user screen. In at least one embodiment, the CI program 110a, 110b may highlight a directional arrow to guide the first user 204 to move a cursor from a current cursor position towards the respective direction of the highlighted directional arrow. For example, the UI overlay 304 may highlight the arrow pointing up to instruct the first user 204 to move the cursor up from the current cursor position 306, may highlight the arrow pointing down to instruct the first user 204 to move the cursor down from the current cursor position 306, may highlight the arrow pointing to the left or right to instruct the first user 204 to move the cursor to the left or right (respectively) from the current cursor position 306, and may highlight the arrow pointing to a diagonal corner to instruct the first user 204 to move the cursor towards that diagonal corner from the current cursor position 306.

In one use case of the relative navigational hint 302, a user A (e.g., first user 204) may follow along in a screen sharing session with a technical specialist (e.g., second user 208) who is helping user A with a software application. The technical specialist may talk to user A regarding a topic that is on the left side of the software application page such that the user A may need to navigate to that part of the application page. As the technical specialist talks about the left part of the application page, the CI program 110a, 110b may implement the relative navigational hint 302 to “navigate left” in the form of a highlighted arrow showing user A to push the cursor to the left to navigate to the left. User A may follow the on screen relative navigational hint 302 to navigate to the left part of the application page. Once the proper placement is reached on the screen, the CI program 110a, 110b may remove the UI overlay 304 of the relative navigational hint 302.

According to one embodiment, the CI program 110a, 110b may provide automatic cursor repositioning 308. In one embodiment, the CI program 110a, 110b may implement the automatic cursor repositioning 308 to automatically move the cursor or pointer of the first user device 206 to a specific element 310 and/or in a given direction 312 based on the action instructed by the second user 208. In one embodiment, the automatic cursor repositioning 308 may be implemented in conjunction with the NLP component 220 and the OCR component 222 to move the cursor to specific elements 310, such as, for example, an input field, a hot/hyperlink, a toggle/radio button, a text (e.g., keyword, phrase).

In one use case of the automatic cursor repositioning 308, a user B (e.g., first user 204) may follow along in a screen sharing session with a technical specialist (e.g., second user 208) who is helping user B with a software application. User B may be new to online learning and sometimes may not be able to move the cursor to the correct place as instructed by the technical specialist. The CI program 110a, 110b may provide user B with an instructional “direction” indicator (e.g., direction 312) to move the cursor pointer in real time. The CI program 110a, 110b may indicate to user B the current point 314 of cursor (e.g., the origin) and also the intended target destination (e.g., specific element 310) where the cursor needs to be moved to. In one embodiment, the CI program 110a, 110b may provide a navigational path (e.g., direction 312) that the cursor can take to get from the current origin (e.g., current point 314) to the intended destination (e.g., specific element 310) onscreen. Once the proper placement (e.g., cursor targeting area; specific element 310) is reached on the screen, the CI program 110a, 110b may stop the automatic cursor repositioning 308.

According to one embodiment, the CI program 110a, 110b may provide shadowing and eye tracking 316. In one embodiment, the shadowing and eye tracking 316 may capture the relative position 318 of the cursor on the screen and/or the eye focus 320 of the first user 204 based on the camera feed. This input may be used to display a navigation cue 322 to guide the first user 204 to an area of the first user screen indicated by the action (e.g., from second user feedback). In one embodiment, the navigation cue 322 may include graphically annotating (e.g., applying a color to the cursor/pointer; applying a shape around the cursor/pointer) a portion of the first user screen to assist the first user to move a cursor to the graphically annotated portion. In one embodiment, the graphically annotated portion may be highlighted in a manner that is easy to see by the first user 204.

In some embodiments, the CI program 110a, 110b may also apply an annotation 324 to the cursor (e.g., cursor of first user device 206) on the screen to enable the second user 208 to easily locate the cursor when instructing the first user 204. In one embodiment, annotation 324 may include any graphical methods (e.g., applying a color to the cursor/pointer; applying a shape around the cursor/pointer) to make the cursor easier to see.

In one use case of the shadowing and eye tracking 316, a user C (e.g., first user 204) may follow along in a screen sharing session with a technical specialist (e.g., second user 208) who is helping user C with a software application. In this example, user C is unable to find the proper location to move the cursor. The CI program 110a, 110b may determine from the user profile that user C has a macular degeneration that restricts the user's ability to see small onscreen cursor movements. As such, the shadowing and eye tracking 316 takes an action to highlight a larger section of the screen with a large red square overlay (e.g., navigation cue 322) to aid user C in moving the cursor to the intended area. Once the cursor reaches the intended area, the CI program 110a, 110b may disable the highlighted area to provide user C with confirmation that the cursor was moved to the correct area.

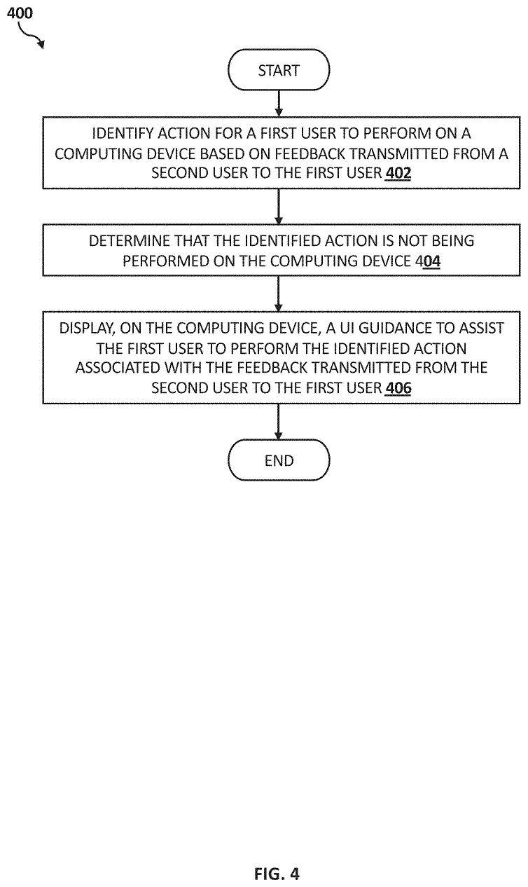

Referring now to FIG. 4, an operational flowchart illustrating the exemplary collaborative interaction (CI) process 400 used by the CI program 110a,110b according to at least one embodiment is depicted. According to one embodiment, FIG. 4 provides a general description of the CI process 400 which was previously detailed with reference to FIGS. 2 and 3.

At 402, an action for a first user to perform on a computing device based on a feedback transmitted from a second user to the first user is identified. According to one embodiment, a first user (e.g., first user 204) may interact with the CI program 110a, 110b to integrate the CI program 110a, 110b with a collaborative platform (e.g., collaborative platform 210) for hosting virtual meetings. In one embodiment, the computing device may refer to the computing device associated with the first user (e.g., first user device 206). According to one embodiment, the virtual meeting may be initiated by the first user for the purpose of receiving technical or product support, user education, or transfer of knowledge from a second user (e.g., second user 208). In one embodiment, the CI program 110a, 110b may receive an approval from the first user indicating the second user as an authorized speaker. In one embodiment, receiving the approval for the second user may enable the CI program 110a, 110b to process the feedback transmitted from the second user for providing assisted collaborative UI navigation.

According to one embodiment, once the first user begins a screen sharing session with one or more external participants (e.g., including the second user 208), the CI program 110a, 110b may capture the audio input streams (e.g., audio input stream 230) received via user device (e.g., second user device 210) of the authorized speaker (e.g., second user 208). In one embodiment, the CI program 110a, 110b may then transcribe the audio input streams into text data (e.g., speech-to-text component 218), as described previously with reference to FIG. 2. Then, the CI program 110a, 110b may execute natural language understanding (NLU) (e.g., via NLP component 220) and classification (e.g., via knowledge base component 224 and knowledge base 232) based on the text data of the audio input streams to determine if the text data includes an action criteria.

According to one embodiment, responsive to determining that the classified audio input stream includes an action criteria, the action to be performed on the computing device based on the feedback from the second user may be identified. According to one embodiment, once the text data is classified as including the action criteria, the CI program 110a, 110b may identify the action indicated in the classified audio input stream based on the metadata extracted from the text, as previously described with reference to FIG. 2.

Then at 404, a determination is made that the identified action is not being performed on the computing device. According to one embodiment, the CI program 110a, 110b may track one or more cursor movements (e.g., via UI component 226) of the first user device to determine if the first user is performing the actions instructed by the authorized speaker (e.g., second user 208). According to one embodiment, the CI program 110a, 110b may implement (e.g., retrieve) a triggering threshold associated with the first user, as previously described with reference to FIG. 2. In one embodiment, the CI program 110a, 110b may determine that the first user has not performed the identified action if a timeframe indicated by the triggering threshold has passed, as described previously with reference to FIG. 2.

Thereafter at 406, a user interface (UI) guidance is displayed on the computing device to assist the first user to perform the identified action associated with the feedback transmitted from the second user to the first user. According to one embodiment, if the CI program 110a, 110b determines that the first user has not performed the correct action within the triggering threshold, the CI program 110a, 110b may execute one or more UI guidance actions to assist the first user in completing the action instructed by the second user (e.g., authorized speaker), as described previously with reference to FIGS. 2 and 3. In various embodiments, the UI guidance actions may include a relative navigational hint, automatic cursor repositioning, and/or shadowing and eye tracking, as described previously with reference to FIGS. 2 and 3. According to one embodiment, once the correct action is registered as being completed by the first user, the CI program 110a, 110b may disable the UI guidance and capture user feedback for future presenter (e.g., first user 204) and viewer (e.g., authorized speaker; second user 208) iterations to guide in future screen sharing sessions.

Accordingly, the CI program 110a, 110b may improve the functionality of a computer because the CI program 110a, 110b may enable the computer to translate the intent of a verbal command (e.g., given from second user to first user, not user to device) or instruction using NLP and provide visual guidance on screen to help the first user accomplish the direction/instructions from the second user.

It may be appreciated that FIGS. 2 to 4 provide only an illustration of one embodiment and do not imply any limitations with regard to how different embodiments may be implemented. Many modifications to the depicted embodiment(s) may be made based on design and implementation requirements.

FIG. 5 is a block diagram 900 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 5. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the CI program 110a in client computer 102, and the CI program 110b in network server 112, may be stored on one or more computer-readable tangible storage devices 916 for execution by one or more processors 906 via one or more RAMs 908 (which typically include cache memory). In the embodiment illustrated in FIG. 5, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the CI program 110a and 110b can be stored on one or more of the respective portable computer-readable tangible storage devices 920, read via the respective RAY drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the CI program 110a in client computer 102 and the CI program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the CI program 110a in client computer 102 and the CI program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

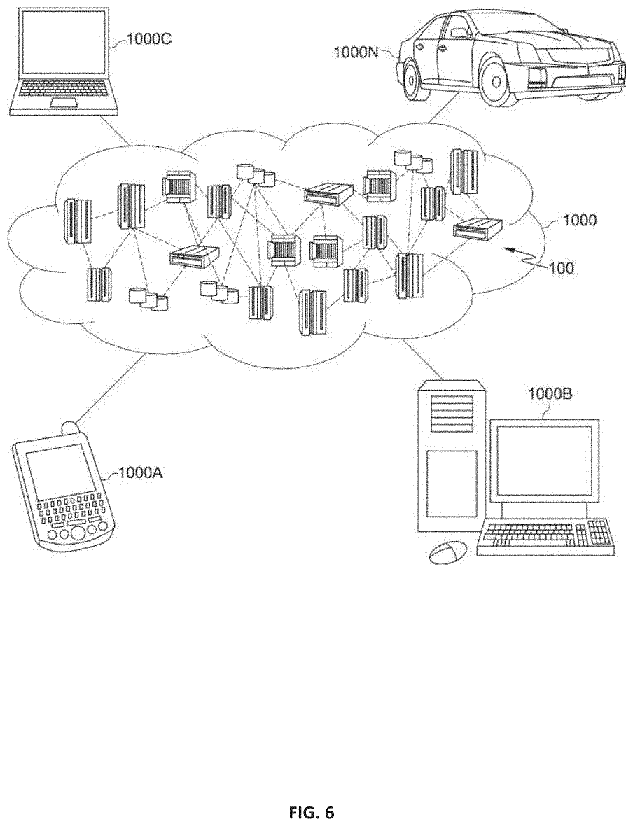

Referring now to FIG. 6, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 6 are intended to be illustrative only and that computing nodes 100 and cloud computing environment 1000 can communicate with any type of computerized device over any type of network and/or network addressable connection (e.g., using a web browser).

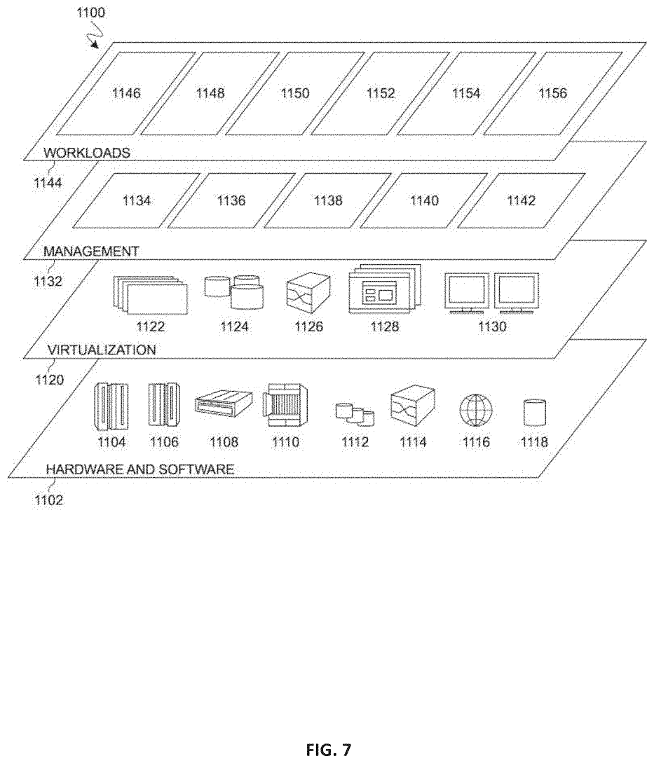

Referring now to FIG. 7, a set of functional abstraction layers 1100 provided by cloud computing environment 1000 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and assisted collaborative navigation 1156. A CI program 110a, 110b provides a way to display a user interface guidance to assist a first user to perform an identified action associated with a feedback transmitted from a second user to a first user.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
identifying an action for a first user to perform on a computing device based on a feedback transmitted from a second user to the first user;
determining that the identified action is not being performed on the computing device; and
displaying, on the computing device, a user interface (UI) guidance to assist the first user to perform the identified action associated with the feedback transmitted from the second user to the first user.

2. The method of claim 1, further comprising:
receiving an approval from the first user indicating the second user as an authorized speaker; and
processing the feedback transmitted from the second user based on the received approval.

3. The method of claim 1, wherein identifying the action for the first user to perform on the computing device based on the feedback transmitted from the second user to the first user further comprises:
capturing an audio input stream from the second user;
transcribing the captured audio input stream to a text data; and
classifying the text data as including an action criteria.

4. The method of claim 1, further comprising:
tracking at least one cursor movement of the computing device associated with the first user to determine if the identified action is being performed on the computing device.

5. The method of claim 1, wherein determining that the identified action is not being performed on the computing device further comprises:
retrieving a triggering threshold associated with the first user; and
determining that the identified action is not performed within a timeframe indicated by the retrieved triggering threshold.

6. The method of claim 1, wherein displaying the UI guidance further comprises:
displaying a quad arrow, wherein each directional arrow of the displayed quad arrow is associated with a respective direction on a first user screen; and
highlighting the directional arrow associated with guiding the first user to move a cursor from a current cursor position towards the respective direction of the highlighted directional arrow.

7. The method of claim 1, wherein displaying the UI guidance further comprises:
automatically repositioning a cursor on a first user screen from a current position to a specific element on the first user screen based on the identified action.

8. The method of claim 1, wherein displaying the UI guidance further comprises:
graphically annotating a portion of a first user screen to assist the first user to move a cursor to the graphically annotated portion, wherein the graphically annotated portion is associated with an area of the first user screen indicated by the identified action.

9. A computer system for assisted collaborative navigation in a screen share environment, comprising:
one or more processors, one or more computer-readable memories, one or more computer-readable tangible storage media, and program instructions stored on at least one of the one or more computer-readable tangible storage media for execution by at least one of the one or more processors via at least one of the one or more memories, wherein the computer system is capable of performing a method comprising:
identifying an action for a first user to perform on a computing device based on a feedback transmitted from a second user to the first user;
determining that the identified action is not being performed on the computing device; and
displaying, on the computing device, a user interface (UI) guidance to assist the first user to perform the identified action associated with the feedback transmitted from the second user to the first user.

10. The computer system of claim 9, further comprising:
receiving an approval from the first user indicating the second user as an authorized speaker; and
processing the feedback transmitted from the second user based on the received approval.

11. The computer system of claim 9, wherein identifying the action for the first user to perform on the computing device based on the feedback transmitted from the second user to the first user further comprises:
capturing an audio input stream from the second user;
transcribing the captured audio input stream to a text data; and
classifying the text data as including an action criteria.

12. The computer system of claim 9, further comprising:
tracking at least one cursor movement of the computing device associated with the first user to determine if the identified action is being performed on the computing device.

13. The computer system of claim 9, wherein determining that the identified action is not being performed on the computing device further comprises:
retrieving a triggering threshold associated with the first user; and
determining that the identified action is not performed within a timeframe indicated by the retrieved triggering threshold.

14. The computer system of claim 9, wherein displaying the UI guidance further comprises:
displaying a quad arrow, wherein each directional arrow of the displayed quad arrow is associated with a respective direction on a first user screen; and
highlighting the directional arrow associated with guiding the first user to move a cursor from a current cursor position towards the respective direction of the highlighted directional arrow.

15. The computer system of claim 9, wherein displaying the UI guidance further comprises:
automatically repositioning a cursor on a first user screen from a current position to a specific element on the first user screen based on the identified action.

16. The computer system of claim 9, wherein displaying the UI guidance further comprises:
graphically annotating a portion of a first user screen to assist the first user to move a cursor to the graphically annotated portion, wherein the graphically annotated portion is associated with an area of the first user screen indicated by the identified action.

17. A computer program product for assisted collaborative navigation in a screen share environment, comprising:
one or more computer-readable storage media and program instructions collectively stored on the one or more computer-readable storage media, the program instructions executable by a processor to cause the processor to perform a method comprising:
identifying an action for a first user to perform on a computing device based on a feedback transmitted from a second user to the first user;
determining that the identified action is not being performed on the computing device; and
displaying, on the computing device, a user interface (UI) guidance to assist the first user to perform the identified action associated with the feedback transmitted from the second user to the first user.

18. The computer program product of claim 17, further comprising:
receiving an approval from the first user indicating the second user as an authorized speaker; and
processing the feedback transmitted from the second user based on the received approval.

19. The computer program product of claim 17, wherein identifying the action for the first user to perform on the computing device based on the feedback transmitted from the second user to the first user further comprises:
capturing an audio input stream from the second user;
transcribing the captured audio input stream to a text data; and
classifying the text data as including an action criteria.

20. The computer program product of claim 17, further comprising:
tracking at least one cursor movement of the computing device associated with the first user to determine if the identified action is being performed on the computing device.
